(19) United States
(12) Patent Application Publication
(10) Pub. No.: US 2026/0001218 A1
(43) Pub. Date: Jan. 1, 2026

(54) Systems and Methods for Robotic System Control Using Generative Models

(71) Applicant: Covariant, Inc., Emeryville, CA (US)

(72) Inventors: Yang Liu, Emeryville, CA (US); Carlos Florensa, Berkeley, CA (US); Jeremy Welborn, San Francisco, CA (US); Nikhil Mishra, Oakland, CA (US); Anusha Nagabandi, Oakland, CA (US); Hassan Farooq, Fremont, CA (US); Varun Vijay, Emeryville, CA (US); Juyue Chen, Emeryville, CA (US); Daniel Adelberg, Berkeley, CA (US); Andrew Sohn, Los Angeles, CA (US); Yan Duan, Emeryville, CA (US); Pieter Abbeel, Orinda, CA (US); Xi Chen, Hillsborough, CA (US)

(21) Appl. No.: 19/250,801

(22) Filed: Jun. 26, 2025

Related U.S. Application Data
(60) Provisional application No. 63/664,596, filed on Jun. 26, 2024.

(51) Int. Cl. B25J 9/16; B25J 13/08; B25J 19/02

(52) U.S. Cl. CPC B25J 9/163; B25J 9/161; B25J 13/08; B25J 19/023

(57) ABSTRACT

In one embodiment, a method includes receiving a natural language instruction from an interface device, receiving sensor data of a physical environment from a sensing system, converting the natural language instruction into instruction tokens and the sensor data into sensor tokens. The method further includes executing an autoregressive generative model on the instruction tokens and sensor tokens to output control tokens. The method further includes generating control commands based on the control tokens and transmitting the control commands to a robotic system. The control commands cause the robotic system to perform an action affecting the physical environment.

### BENEFIT CLAIM

This application claims the benefit under 35 U.S.C. § 119(e) of provisional application 63/664,596, filed Jun. 26, 2024, the entire content of which is hereby incorporated by reference for all purposes as if fully set forth herein.

### FIELD OF THE INVENTION

The present invention relates generally to the use of autoregressive generative models for the control and simulation of robotic systems affecting the physical environment.

### BACKGROUND

Artificial intelligence (AI) language models have seen significant development in recent years. In particular, a specific type of model has risen to prominence in the field of natural language processing—the autoregressive sequence-to-sequence model. These models can take an input sequence and generate an output sequence to accomplish a task in natural language processing. These models take as input natural language text, tokenize it into discrete tokens, such as letters, words, or fragments of words, and output another sequence of tokens which can be converted back into natural text. These autoregressive sequence-to-sequence models have been shown to have significant capabilities across a wide range of natural language tasks, such as translation, summarization, and question-answering.

The development came in the 2017 paper “Attention is All You Need,” which introduced the “attention mechanism” to existing sequence-to-sequence models to better understand relationships among tokens in the input. It introduced a new form of autoregressive model called the “transformer” incorporating this attention mechanism. This attention-based approach allows for efficient parallel processing of data. It captures long-range dependencies, marking a significant improvement over previous models such as Recurrent Neural Networks (RNNs) and Long Short-Term Memory (LSTMs) within their intended text-processing applications, and has since become foundational in developing advanced language models.

The initial application of these models was translating sequences of text. However, it was soon discovered that transformers could be used to predict the next token to follow an existing sequence of tokens. This behavior, in combination with various forms of reinforcement learning, leads to the development of transformer-based generative chatbots that are now used widely in natural language processing.

However, these models have a much broader application than merely natural language tasks. The transformer model has been extended to generate content in visual modalities, such as images and videos. This extension was significantly advanced with the development of visual tokenizers, which convert pixel-based inputs into discrete tokens that language models can process similarly to words in text. Recent innovations have demonstrated that language models can be used in place of diffusion models in visual generation tasks. This advancement unifies the processing of certain visual and textual data, facilitating the development of multimodal language models capable of understanding and generating content across different forms of media.

Given these developments, language models appear to be capable of simulating or understanding the physical environment to some extent, as evidenced by their ability to generate synthetic images and video. However, such applications remain confined to the generation of digital content and do not provide for direct control of physical apparatuses. Furthermore, language models have not yet been adapted to interact with the physical world through, for example, robotic arms and other physical mechanisms. Indeed, extending language modeling into robotic control necessitates solving numerous key technical challenges, such as processing heterogeneous, real-time sensor data and generating precise, low-level motor commands in a closed loop. Aspects of the current disclosed technology solve these problems, enabling robotic systems to be powered by language models.

### SUMMARY

In some embodiments, a method includes, by one or more computing systems: electronically receiving, from an interface device, a first natural language instruction including text data; electronically receiving, from a sensing system, sensor data associated with a physical environment; converting the first natural language instruction into a plurality of instruction tokens and the sensor data into a plurality of sensor tokens; executing an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generating one or more first control commands based on the control tokens; and electronically transmitting the first control commands to a robotic system, the first control commands causing the robotic system to perform an action affecting the physical environment.

In some embodiments, the method further includes: electronically receiving, from the interface device, a second natural language instruction including text data; and performing a task including a plurality of actions by iteratively providing the second natural language instruction and sensor data corresponding to a current state of the robotic system to the autoregressive generative model to generate a second control command and providing the second control command to the robotic system to act from among the plurality of actions.

In some embodiments, at least one second control command in one iteration is a command to stop performing further actions. The at least one second control command causes the robotic system to stop performing further actions.

In some embodiments, the method further includes: within one iteration: after providing the second control command to the robotic system to perform an action, obtaining sensor data corresponding to the current state of the robotic system after performing the action; detecting an error condition based on the sensor data; and producing an output indicating a presence of the error condition.

In some embodiments, detecting the error condition based on the sensor data includes: analyzing the sensor data to determine the current state of the robotic system; and providing the current state and a prompt to the autoregressive generative model for execution, the execution of the autoregressive generative model outputting the error condition, wherein the prompt specifies a request for the autoregressive generative model to determine whether an error has occurred.

In some embodiments, the method further includes: halting operations of the robotic system.

In some embodiments, the method further includes: within one iteration: after providing the second control command to the robotic system to perform an action, obtaining sensor data corresponding to the current state of the robotic system after performing the action; analyzing the sensor data to determine the current state of the robotic system; providing the current state and a prompt to the autoregressive generative model for execution, the execution of the autoregressive generative model outputting an indication that no error condition is detected, wherein the prompt specifies a request for the autoregressive generative model to determine whether an error has occurred; and producing an output indicating an absence of an error condition.

In some embodiments, the method further includes: within one iteration: prior to providing the second control command to the robotic system to perform an action, providing the autoregressive generative model with the control command and the current state to produce simulated sensor data corresponding to a future state of the robotic system following the execution of the second control command; and providing the autoregressive generative model with the simulated sensor data and a prompt to determine a presence or an absence of an error condition, wherein the prompt specifies a request for the autoregressive generative model to detect any erroneous condition present in the simulated sensor data.

In some embodiments, the autoregressive generative model determines a presence of an error condition, the method further including: halting operations of the robotic system; and producing an output indicating a presence of the error condition.

In some embodiments, the method further includes: in response to an output mode command, outputting video, image, or expected sensor data corresponding to an expected state of the robotic system after performing the action.

In some embodiments, the sensing system includes one or more sensors.

In some embodiments, the one or more sensors are configured to provide data corresponding to a current pose of the robotic system.

In some embodiments, the sensor data indicates one or more of mass, tilt, orientation, temperature, humidity, rigidity, vibrations, atmospheric temperature, atmospheric composition, light exposure, acoustic levels, electromagnetic fields, airflow, radiation, or RFID identifiers. In some embodiments, the sensing system includes an imaging system.

In some embodiments, the imaging system includes one or more of a visible light camera, an infrared camera, a LIDAR sensor, a RADAR sensor, or an ultrasonic sensor.

In some embodiments, the method further includes: receiving a second natural language instruction to place a first item in a first output area selected from a plurality of output areas, wherein the first item is selected from a plurality of items in a work area in the physical environment; and responsive to the second natural language instruction, transmitting a control command corresponding to the second natural language instruction to the robotic system, wherein the control command causes the robotic system to move the first item to the first output area.

In some embodiments, the one or more first control commands specify one or more of a specific position for the robotic system, a specific pose for the robotic system, a delta command to move a specific joint of the robotic system a specific distance, or a delta command to move a specific actuator of the robotic system a specific distance.

In some embodiments, the autoregressive generative model is a transformer model.

In some embodiments, a system includes: a sensing system including one or more sensors configured to observe a physical environment and produce sensor data in response to the physical environment; a robotic system configured to receive control commands to perform an action affecting the physical environment; and a control system including one or more processors and a non-transitory memory coupled to the processors including instructions executable by the processors, the processors operable when executing the instructions to: electronically receive, from an interface device, a first natural language instruction including text data; electronically receive, from the sensing system, sensor data associated with the physical environment; convert the first natural language instruction into a plurality of instruction tokens and the sensor data into a plurality of sensor tokens; execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generate one or more first control commands based on the control tokens; and electronically transmit the first control commands to the robotic system, the first control commands causing the robotic system to perform an action affecting the physical environment.

In some embodiments, one or more computer-readable non-transitory storage media embodies software that is operable when executed to: electronically receive, from an interface device, a first natural language instruction including text data; electronically receive, from a sensing system, sensor data associated with a physical environment; convert the first natural language instruction into a plurality of instruction tokens and the sensor data into a plurality of sensor tokens; execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generate one or more first control commands based on the control tokens; and electronically transmit the first control commands to a robotic system, the first control commands causing the robotic system to perform an action affecting the physical environment.

Technical advantages of certain embodiments of this disclosure may include one or more of the following. The disclosed systems and methods utilize a transformer-based autoregressive generative model capable of processing and generating multiple data modalities (text, image, video, sensor data, and control commands), enabling seamless integration of diverse input types for more intelligent and context-aware robotic control. The disclosed systems and methods allow users to control robotic systems using natural language instructions, reducing the need for specialized programming knowledge and making robotic systems more accessible and user-friendly. The disclosed systems and methods employ separate tokenizers for each modality, enabling consistent and structured input/output processing, which further supports flexible and scalable vocabulary management across different data types. The disclosed systems and methods implement control loops that continuously observe the environment and generate real-time control commands, enabling dynamic and responsive robotic behavior based on current sensor and imaging data. The disclosed systems and methods integrate error detection mechanisms using the generative model to identify and explain faults and support simulation of future states to preemptively detect and avoid errors before executing commands. The disclosed systems and methods pre-train the autoregressive generative model on general multimodal data and fine-tune it on robotic-specific data, enhancing performance in real-world tasks and allowing for adaptation to specific robotic environments and tasks. The disclosed systems and methods apply to a wide range of robotic systems and tasks, including putwall sorting, depalletization, kitting, and goods-to-person picking. They are compatible with various robotic platforms, including arms, mobile robots, and traditional automation systems. The disclosed systems and methods are designed to support multiple work cells and robotic systems simultaneously, and the modular design allows for easy integration with existing industrial infrastructure.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE FIGURES

FIG. 1 depicts a work cell in accordance with embodiments.

FIG. 2 depicts an autoregressive generative model in accordance with embodiments.

FIG. 3 depicts the various bi-directional encoders used in accordance with embodiments.

FIG. 4 depicts a vocabulary for use with an autoregressive generative model in accordance with embodiments.

FIG. 5 depicts a control loop in accordance with embodiments.

FIG. 6 depicts another control loop in accordance with embodiments.

FIG. 7 depicts another control loop in accordance with embodiments.

FIG. 8 depicts a putwall work cell in accordance with embodiments.

FIG. 9 depicts a depalletization work cell in accordance with embodiments.

FIG. 10 depicts a computer system in accordance with embodiments.

### DETAILED DESCRIPTION

The following detailed description is directed to systems and methods for robotic system control using autoregressive generative models.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

The term “comprising” or “containing” or “including” is meant that at least the named element, material, or method step is present in the composition or article or method, but does not exclude the presence of other elements, materials, or method steps, even if the other such elements, material, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific embodiments or examples. In referring to the drawings, like numerals represent like elements throughout the several figures.

Various products and services provided by third parties are mentioned as example components of embodiments in accordance with the disclosed technologies. The use of trademarked (registered or common-law) names are intended for descriptive purposes only-no claim of ownership over those terms is asserted by the applicants by this application. Further, the mention of a trademarked product or service is as an example only. Other products and services providing equivalent functions, whether commercial, open-source, or custom-developed to support embodiments are contemplated in accordance with the disclosed technology.

Certain examples of the disclosed technology are discussed and shown herein using names, addresses, behavioral attributes, financial data, and other forms of personal data. All such data is fictitious. No actual personal data is provided herein. Any correspondence between data provided in this application and actual persons, living or dead, is purely coincidental. In addition, the examples of business metrics are merely examples. Embodiments of the present disclosed technology are not limited to merely these metrics.

Aspects of the disclosed technology relate to a generative model for robotics control, and various specific applications of that model to perform tasks using robotic systems. The model is a multimodal transformer model capable of receiving data in a plurality of formats or modalities and outputting data in a plurality of formats or modalities.

The systems and methods disclosed herein provide a specific technical solution to a technical problem rooted in the field of robotics and industrial automation. Specifically, the invention addresses the challenge of creating a sufficiently responsive, adaptable, and integrated control system for a robot that must interact with a dynamic physical environment. The technical effect of the present invention is the transformation of a generic, pre-trained generative model into a specialized, real-time robotic control component that directly causes physical actions. This is achieved by fine-tuning the model on specific robotic data types and integrating it into a direct control loop, which improves the functioning of the robotic system itself by enabling it to dynamically generate precise, low-level control commands from high-level, multimodal inputs (such as natural language and real-time sensor data). This results in a more efficient and versatile robotic system that can adapt to new tasks without manual reprogramming, and can even preemptively identify and avoid physical errors through simulation, effects which are concrete, technical improvements to the field of robotic control.

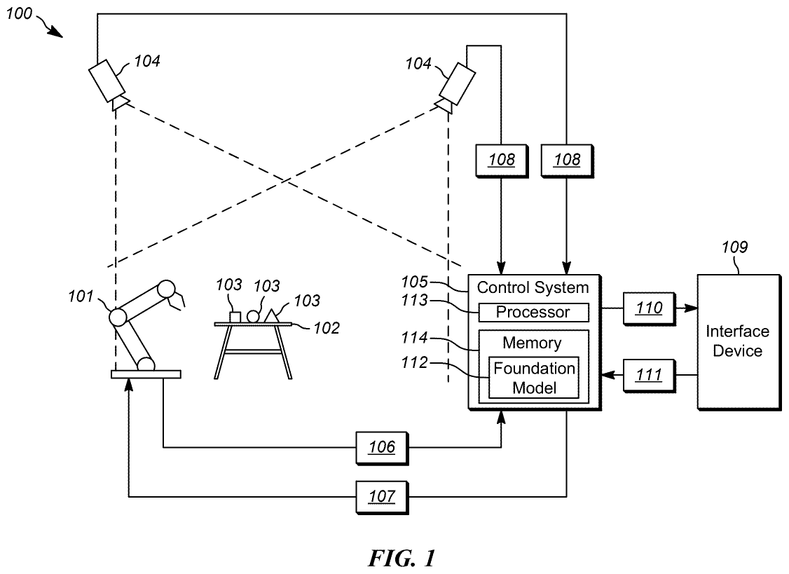

FIG. 1 depicts a work cell 100 in accordance with an embodiment. The work cell 100 comprises a robotic system 101, a work surface 102 with a plurality of objects 103, one or more imaging systems/devices 104, and a control system 105. The robotic system 101 can be configured to send sensor data 106 to the control system 105, and to receive control commands 107 from the control system 105. In some embodiments, sensor data 106 may also be sent from sensors separate from robotic system 101. For example, sensors may be placed on, underneath, or within work surface 102 or within work cell 100. Sensors may also be positioned outside of work cell 100 to collect data related to multiple work cells. Such sensors may be configured to collect sensor data 106 reflecting: mass, tilt, orientation, temperature, humidity, rigidity, vibrations, atmospheric temperature, atmospheric composition, light exposure, acoustic levels, electromagnetic fields, airflow, radiation, RFID identifiers, etc. The one or more imaging systems/devices 104 are configured to send imaging data 108 to the control system 105. The one or more imaging systems/devices 104 can be any device capable of generating image data about the work cell 100, such as visible light cameras, infrared cameras, LIDAR or RADAR sensors, ultrasonic sensors, and similar devices.

The control system 105 comprises one or more processors 113 and a memory 114 coupled to the processor 113. The processor 113 is configured to execute instructions stored in the memory 114 to perform various computational tasks. The processor may be any suitable computing unit capable of executing machine-readable instructions. The processor may include multiple cores and support parallel processing to enhance performance for data-intensive operations. The memory 114 stores both executable instructions and data required during runtime. The memory 114 may include volatile and non-volatile storage components. The memory 114 stores operating system and application software, intermediate and final data structures, machine learning models, and parameters.

The memory 114 stores a foundation model 112, which is configured to receive the sensor data 106 and the imaging data 108 and, responsive to the sensor data 106 and imaging data 108, produce one or more control commands 107 to be sent to the robotic system 101 to perform an action using the model 112. The work cell 100 can include an interface device 109 for communicating with the control system 105. The interface device can receive information 110, such as text, images, and video, from the control system 105, and provide input commands (instructions) 111 in the form of text, images, and video to the control system 105. In some embodiments, the interface device 109 can be a panel in proximity to the work cell 100. In some embodiments, the interface device 109 can be a mobile device, such as a laptop or a mobile phone, communicating with the control system 105 over a network, including the internet. In some embodiments, the interface device 109 can be an industrial control system associated with the facility in which the work cell 100 is located, or in a centralized off-site control facility.

In some embodiments, the model 112 is an autoregressive generative model configured to take as input a sequence of tokens and produce a probability distribution of potential next tokens in the sequence. This kind of model is generally known as autoregressive sequence-to-sequence models. By selecting a high-likelihood token from the probability distribution and appending it to the input sequence, and then repeating the process of calculating a probability distribution for the next token, the model 112 can be configured to output a sequence of predicted next tokens. Any autoregressive generative model capable of next-token prediction can be used in accordance with embodiments. One example of an autoregressive generative model is the “transformer” model, as originally introduced in the 2017 paper “Attention is All You Need” by Vaswani et al. The original transformer described in that paper is a type of autoregressive sequence-to-sequence model which maps each token in the input sequence to an embedding vector, which is fed as a matrix into an alternating series of multi-headed attention and multi-layer perceptron layers as is known in the art. Subsequent applications have modified the transformer to be a “decoder-only” transformer, wherein the entire input sequence is not known, and the model is used to predict the next token in a sequence.

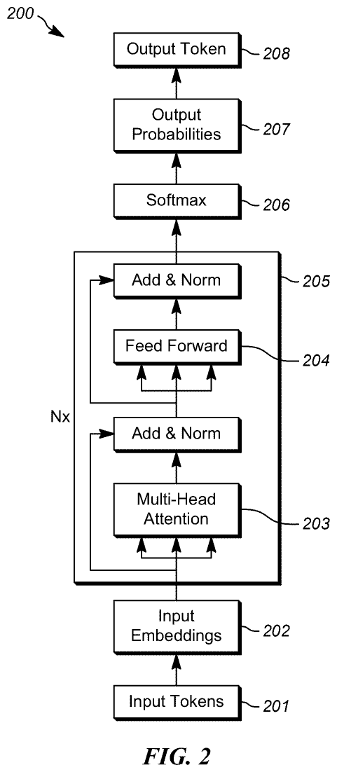

FIG. 2 depicts a decoder-only transformer model 200 in accordance with embodiments. The transformer model 200 takes as input a sequence of input tokens 201, which are then translated into an input matrix of embeddings corresponding to the input tokens 202. Once the input matrix is assembled, it passes through several alternating layers 205, where each layer contains a multi-headed attention layer 203, and a feed forward network 204. After the final layer, the resulting matrix is a matrix of logits, where each column represents the next position in the sequence from the input matrix. The last column represents the probability distribution of whether each token is the next token in the sequence. These logits are passed through a softmax layer 206 to convert them to scaled output probabilities 207, summing to 1. One of the tokens in the distribution can be selected as the next token by, for example, picking one of the most probable next tokens, providing an output token 208. Models of this kind have many trainable parameters, including but not limited to the embeddings for input tokens, weights in the multilayer perceptron layers, and key-query-value matrices for each of the multi-headed attention layers. The output of the transformer is a matrix where each column represents a position in the sequence, and each row represents a probability for each token in the model's vocabulary. The next token predicted by the model can be determined by looking at the highest probability token or tokens in the last column of the output matrix.

Aspects of the present disclosure can include the transformer as initially proposed by “Attention is All You Need,” including any improvements currently known or later developed that increase the performance of the model to predict the next token, or reduce the computational requirements for predicting the next token. As would be understood in the art, this includes at least techniques that encode position information about the input sequence of tokens, improvements to the attention mechanism (such as sparse attention, KV-caches, and the like), and other similar improvements. As the technology of the present disclosure relates to the use of such an autoregressive sequence-to-sequence model for robotic control, the use of any such improvements is contemplated hereby.

The collection of all possible input and output tokens is referred to as the “vocabulary” of the model. Each token has a corresponding “embedding” which is a vector representation of that token. As explained above, for a given sequence, the transformer creates a matrix comprising the input vectors corresponding to the input tokens, and feeds it through a series of alternating blocks of multi-head attention blocks, and multi-layer perceptrons (i.e., feed forward networks). The transformer outputs a matrix of output vectors, each vector in the output vectors corresponding to the probability that the next token should be each token in the vocabulary.

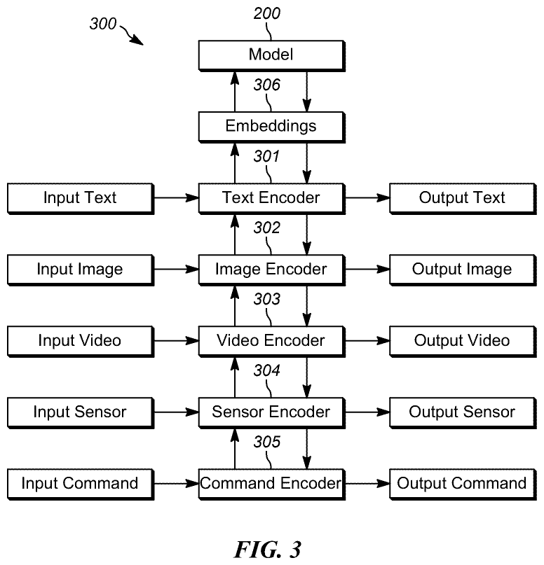

FIG. 3 is a diagram depicting a multimodal bidirectional encoder 300 in accordance with an embodiment. In some embodiments, the transformer is capable of receiving as input, and producing as output, a variety of modalities, such as text, images, video, and sensor data, and outputting the same collection of modalities. In some embodiments, each modality has its own separate encoder/decoder to encode data from its native format (or a preprocessed variant thereof) into a plurality of tokens having a numeric or other identifier, and of reversing the process from a set of numeric token identifiers to the original native format. For example, a separate encoder exists for text 301, images 302, video 303, sensor data 304, and commands 305. Each encoder is capable of converting data in a native input format into a token ID having a corresponding embedding. The token IDs corresponding to the input data can be used to retrieve corresponding embeddings 306 to pass on to the model 200.

By way of example, some embodiments may provide the ability to input and output text data. Text data comprises a sequence individual characters which, in sequence, can be understood as natural language. A simple bidirectional encoder could be implemented simply by assigning each character present in the training data for the model to a separate token, which would produce a small vocabulary but long input sequences. Another simple bidirectional encoder would be to split the input sequence on word boundaries, and create one token for every word in the training data. This would produce a very large vocabulary, but input sequences would be mapped to a relatively short sequence of tokens. In practice, most text tokenization strategies fall between these extremes, such as byte pair encoding or universal sentence encoding as is known in the art. Aspects of the current disclosed technology can utilize any text tokenization strategy, either known or hereafter discovered in accordance with embodiments.

Likewise, image and video data can be encoded into a sequence of tokens. For example, as described in Lijun Yu et al., Language Model Beats Diffusion (2023), separate machine learning models can be trained to map pixel-space inputs to discrete tokens for both video and image content. Again, the specific methodology used to tokenize video or image content is not critical to uses of embodiments of the present disclosed technology.

Indeed, aspects of the disclosed technology can be used with any modality so long as an appropriate tokenizer is available to convert the input modality to a plurality of tokens. For example, in a non-limiting embodiment, a continuous sensor value such as a robot joint angle reported in degrees is tokenized by quantizing the value into a predefined number of discrete bins. A joint angle range of −180.0 to +180.0 degrees could be quantized into 3600 bins, where each bin represents a 0.1-degree increment. Each of these bins is assigned a unique token ID within the sensor data portion of the model's vocabulary. A reported angle of 91.3 degrees would thus be converted into the token ID corresponding to the ‘91.3’ bin. Each bidirectional encoder can be considered to have its own modality-specific vocabulary comprising a plurality of modality-specific tokens.

The tokenization concept is not limited to continuous kinematic data. For inherently discrete data types, such as an RFID identifier read by an RFID sensor, a direct mapping can be used where each unique RFID tag identifier is assigned a corresponding unique token ID in the sensor vocabulary. Similarly, for other continuous values such as mass measured by a load cell, a range of expected weights (e.g., 0 to 50 kg) can be quantized into a plurality of bins (e.g., 1000 bins of 50 grams each), with each bin being assigned a unique token ID. For more complex, multi-dimensional sensor data, such as data indicative of ‘rigidity’ from a force-torque sensor mounted on a robot's wrist, or ‘vibrations’ from an accelerometer, the raw sensor data may be pre-processed to extract a salient feature. For instance, the peak force measured during a grasping action could be quantized and tokenized to represent rigidity, or a key frequency component from a Fast Fourier Transform (FFT) of the vibration data could be similarly quantized and tokenized. This demonstrates that a wide array of physical properties can be converted into a token-based format suitable for the autoregressive generative model.

In addition, a bidirectional encoder can be provided to produce control commands 107 for the robotic system 101. Control commands can comprise tokens corresponding to specific positions or poses for the robotic system 101, delta commands to move specific joints or actuators specific distances, and other commands understandable by the controlled robotic system 101. For instance, a command to move a specific joint by a certain amount may be tokenized as a sequence of discrete tokens, such as <CMD_START>, <JOINT_5>, <MOVE_RELATIVE>, <PLUS_10_DEGREES>, <SPEED_50_PERCENT>, <CMD_END>, where each component of the command is a distinct token in the control command vocabulary. The control commands can also comprise an “end action” or similar token that indicates that the desired robotic action has been completed. In some embodiments, output control commands may be structured and formatted using languages such as: RAPID, KUKA Robot Language, Karel, INFORM, VAL3, and URScript, or other application-specific languages.

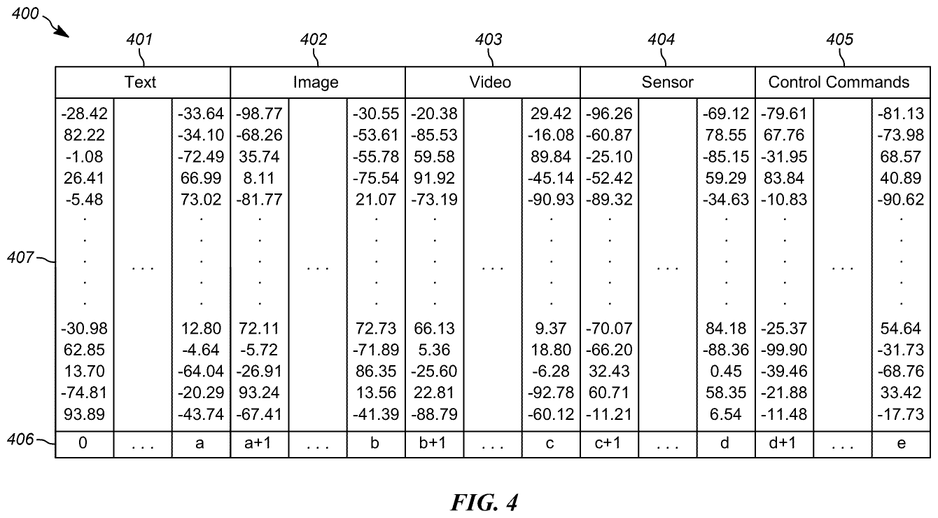

FIG. 4 illustrates a vocabulary 400 in accordance with an embodiment. By utilizing a plurality of bidirectional encoders, a vocabulary for the model can be created by concatenating the modality-specific vocabularies into a single vocabulary for the transformer model. In this example embodiment, tokens from a text encoder 401, image encoder 402, video encoder 403, sensor encoder 404, and control command encoder 405 are concatenated to form the vocabulary for the model 112. Each token has a token ID 406 which uniquely identifies the token, and links it to a corresponding embedding 407. Tokens 0 to “a” are assigned to the vocabulary from a text encoder 401, a+1 to b for an image encoder 402, b+1 c for a video encoder 403, c+1 to d for a sensor data encoder 404, and d+1 to e for control command encoder 405 for the robotic system. As would be understood by a person having ordinary skill in the art, the ordering or sizes of the individual modality-specific vocabularies is not critical to operation of embodiments, so long as the same token IDs are used for both input to, and output from, the model.

In some embodiments, the transformer component of the control system 105 can be pre-trained using data sources derived from the internet, such as websites, encyclopedias, videos, images, or pre-existing data sets curated for computer vision tasks. During this pre-training, the input data is assembled into multimodal sequences that can comprise any of a plurality of pre-training modalities. In an example embodiment, pre-training modalities can include a subset of the modalities used for control of a robotic system 101, such as only text, images, and video.

In some embodiments, after pre-training the transformer model on data not specific to the robotic task to be performed by the robotic system 101, a subsequent fine-tuning step can be performed on robot-specific data. This robot-specific data may comprise multimodal sequences representing cause and effect in the robotic work cell. For example, a single data point in a fine-tuning dataset may consist of an input sequence containing tokens for a natural language command (e.g., “pick up the bottle”), tokens for an image of the current scene, and tokens for the current robot state (e.g., joint angles, end-effector position). The corresponding target output sequence for this data point would be the tokenized representation of the correct control command (e.g., the sequence of tokens representing the command to move the gripper to the bottle's location). The model is then trained to predict this target output sequence when given the input sequence. During this fine-tuning, additional tokens can be added to the transformer model to represent modalities not present during pre-training, such as sensor data or control commands. In some embodiments, the fine-tuning process can include locking embeddings for known modalities (such as text, images, and videos) such that embeddings are only updated for new modalities added to the model. In some embodiments, the transformer model can be permitted to update embeddings for known modalities based on training data used during fine tuning.

During operation, the transformer model can be prompted to produce output in any modality for which there is a bi-directional encoder. The output modality can, in some embodiments, be selected by “masking” or ignoring any tokens in the output distribution that do not correspond to the target output modality. For example, if a prompt is provided seeking output in the form of an image, at each next-token prediction step, any tokens that do not belong to the image encoder vocabulary can be ignored, and the next token selected is thus the highest-probability token corresponding to the desired output modality.

Once the transformer model is fine-tuned on robotic-specific data, the transformer model can be used with a control system 105 to control a robot to perform tasks. In some embodiments, a basic control loop can comprise iteratively prompting the transformer model with a natural language instruction and information about the current state of the work cell, including data from imaging systems/devices 104 and sensor data 106 to provide a current state of the work cell 100, to produce one or more control commands 107 to be performed by the robotic system 101.

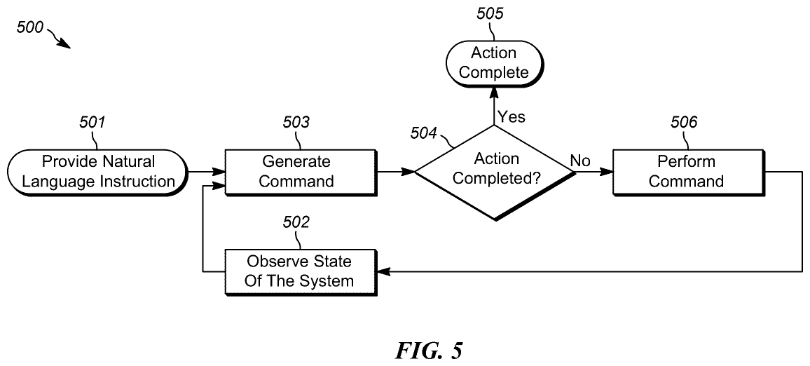

FIG. 5 depicts a control loop 500 in accordance with an embodiment. The control loop begins by receiving a natural language instruction at operation 501, such as “pick up a bottle,” and information from the imaging systems/devices 104 and sensor data 106 about the current state of the work cell 100. The model 112 can be prompted with the natural language instruction and the state of the system observed at operation 502 to produce a command at operation 503 for the robotic system 101. The command is inspected at operation 504 to determine whether the desired command has been completed by producing a command to end the action. If the action has been completed, the system enters an action complete state at operation 505 and takes no further action according to the initial prompt, awaiting further instruction. If the action has not been completed, and the command is for the robot to take an action, the action is then performed at operation 506 by the robotic system 101. Once the command is performed at operation 506, the state of the system is again observed at operation 502 and the state of the system and the natural language instruction are provided to the model 112 to generate the next command at operation 503. Depending on the length of time necessary to observe the system, generate the command, and perform the command, the control loop 500 can be performed multiple times per second, or at longer intervals (e.g., every few seconds) as the specific application demands.

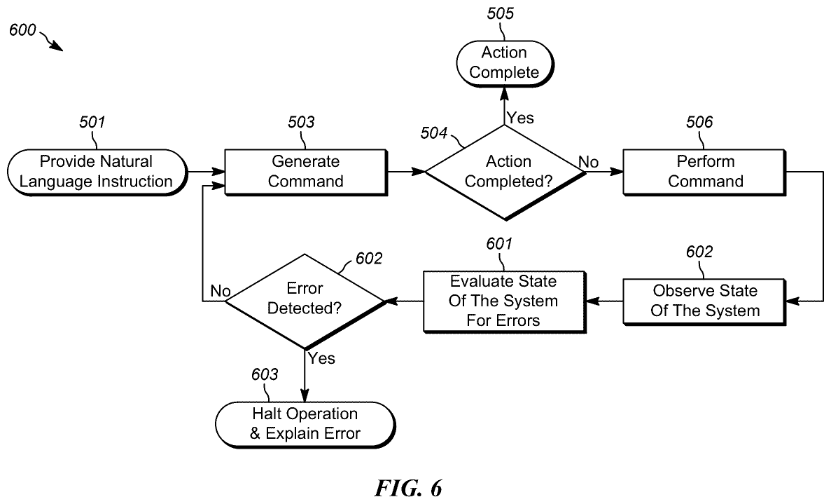

In some embodiments, an error detection feature can be added to the control loop to detect problems in performing the action. FIG. 6 depicts such a control loop 600. In this control loop, the same general steps are performed as in FIG. 5, with the addition of an operation 601 after observation of the system at operation 502 to evaluate the state of the system for errors, and if an error is detected at operation 602, then halting operation of the robotic system and providing a natural language explanation of the error at operation 603. The evaluation of the system's state for errors at operation 601 can be performed by providing the model 112 with the observed state of the system and a natural language prompt asking the model 112 whether an error has occurred, and if so, what the error is. If an error is detected, the robotic system 101 will be halted, and the explanation of the error provided to an end-user at operation 603.

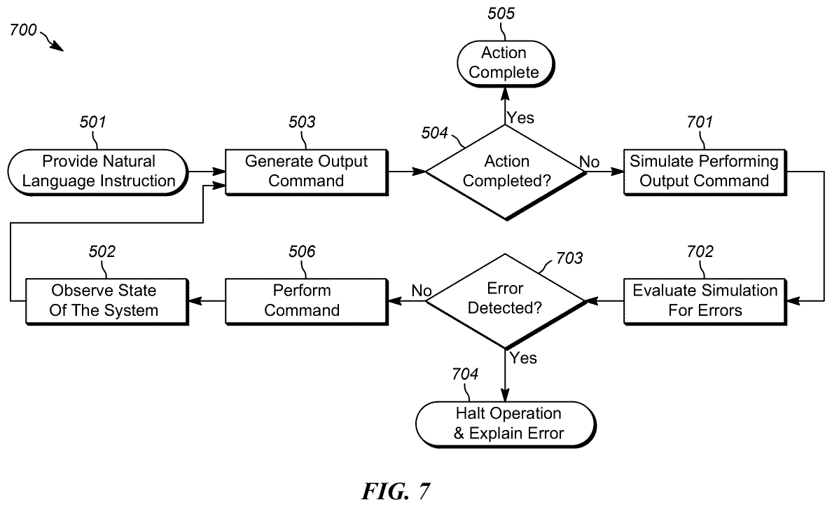

In some embodiments, a simulation feature can be added to the control loop to detect erroneous conditions before such errors occur. FIG. 7 depicts such a control loop 700. The simulation control loop generates an output command in the same manner as the control loop 500, but if the action has not yet been completed, rather than performing the command associated with operation 506, the control system performs a simulation 701 using the model 112 to see what would happen when the command is executed. The simulation can involve prompting the model 112 with at least the output command associated with operation 503 and the observed state of the system associated with operation 502 to produce data representing a potential future state of the robotic system 101, such as an image, video, or simulated sensor data. In the same manner as the control loop 600, the simulation data can be provided to the model 112 in a prompt asking the model 112 to detect any erroneous behavior present in the simulated data associated with operation 702. If an erroneous condition is detected in the simulated data at operation 703, the system can halt the operation of the robotic system, and explain the potential error to a human operator at operation 704.

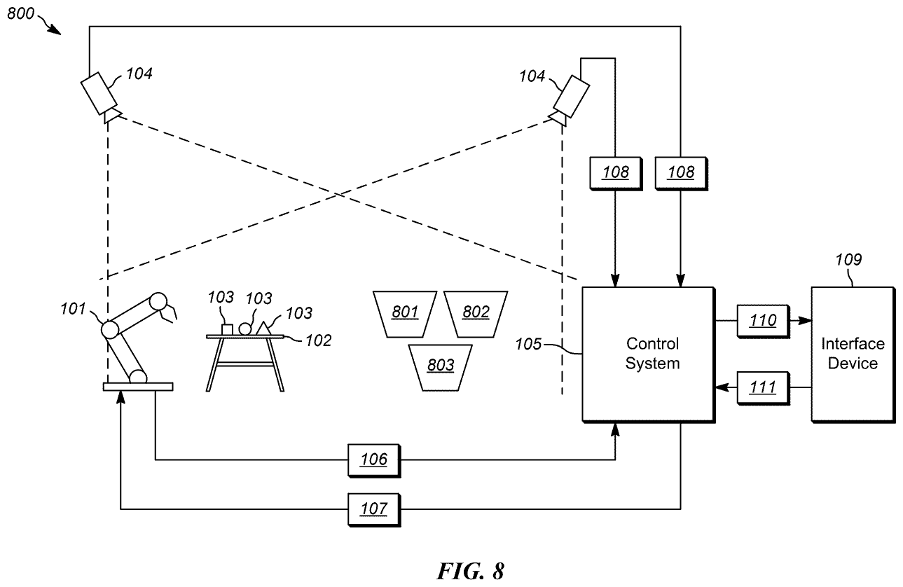

Embodiments of the present invention have a wide variety of specific uses. FIG. 8 depicts an embodiment as a putwall workcell 800. A putwall workcell 800 is a system where a robotic system is tasked with taking an incoming stream of items, and sorting them into one a variety of output bins. Putwalls can be useful in a variety of applications, such as sorting incoming product returns in a warehouse into bins to be distributed to specific departments, or sorting a set of products picked from a warehouse into individual shipments to be sent to customers. In this embodiment, a robotic system 101 has a work surface 102 that is populated with a variety of objects 103. The work surface 102 can be, for example, a flat surface where human workers have deposited various items, the end of a conveyor belt where objects are delivered to the system, or the interior of a tote, among others. The control system 105 can receive an input command 111 from the interface device 109 directing it to place a specific object 103 into one of a specified putwall bins 801, 802, 803. Responsive to the command, the control system 105 uses the model 112 to select the appropriate object 103 from the work surface 102 and place it into the appropriate putwall bin. In other embodiments, the control system 105 can be provided with information regarding the intended contents of the putwall bins 801, 802, 803 and the command can be to place the objects 103 into their appropriate bins. In yet other embodiments, the control system 105 may detect what contents are already within each of putwall bins 801, 802, 803 and sort objects 103 into the appropriate bins that contain similar contents. To the extent that one or more of putwall bins 801, 802, 803 do not yet have contents, the control system 105 can assign such empty bins with a category or kind of object and thereafter sort objects 103 into the assigned bins.

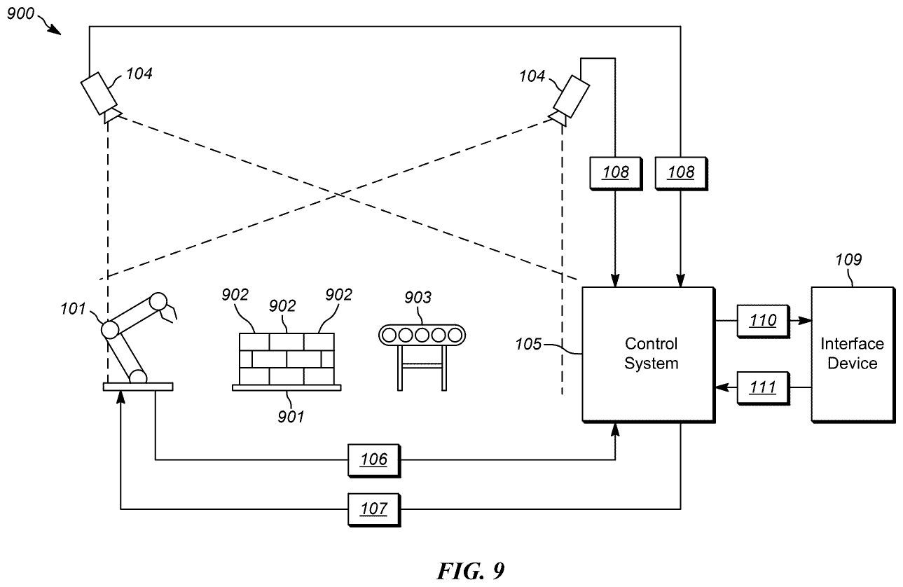

FIG. 9 depicts another embodiment 900 in accordance with the disclosed technology for use with depalletizing goods 902 from pallet 901 and placing them on an output conveyer 903. The control system 105 can receive an input command 111 from the interface device 109 directing it to depalletize the goods 902 from the pallet 901 and put them on the output conveyor 903 until all goods 902 on the pallet 901 are placed on the output conveyor 903. Responsive to the command, the control system 105 uses the model 112 to iteratively pick the goods 902 from the pallet 901 and place them on the output conveyor 903.

Additional variations on these embodiments can comprise applications such as goods-to-person picking, where the robotic system 101 can be used to pick an object from a tote or other container received from a cube storage, shuttle, Autonomous Mobile Robots (AMRs), and other Automated Storage and Retrieval Systems (ASRS). Another embodiment can be used with a plurality of robotic systems 101 for kitting, where each robotic system 101 is responsible for depositing a selected object into a kit or shipment system.

Embodiments of the present invention can be used with a variety of robotic systems. For example, the robotic system can be used with robotic arms with a variety of end-effector systems, such as claws, suction systems, and other gripping or grasping devices, welding end effectors, painting and spraying nozzles, cutting tools, dispensing tools for adhesives, sealants or lubricants, sensors and probes, and others. In addition to robotic arms, aspects of the disclosed technology can be used with other forms of robotic systems, including gantry robots, consumer robotic systems, and humanoid-form factor robots, among others. Aspects of the disclosed technology can be used with any automated system utilizing imaging or vision data capable of affecting a physical environment.

In addition to the robotic systems mentioned above, embodiments of the present invention can also be used with traditional automation systems such as conveyors, sorters, and mobile robots. Conveyors are commonly used in manufacturing and distribution facilities to transport objects from one location to another. These systems can include belt conveyors, roller conveyors, and overhead conveyors, among others. Embodiments of the present invention can be used to enhance the functionality of conveyor systems by integrating robotic systems 101 to perform tasks such as object picking, placement, and sorting along the conveyor path.

Sorters are another type of traditional automation system that can benefit from the integration of robotic systems 101. Sorters are used to automatically separate and direct objects to different destinations based on predefined criteria, such as size, weight, or barcode information. Embodiments of the present invention can be used to improve the accuracy and efficiency of sorters by using robotic systems 101 equipped with advanced vision and sensing capabilities to identify, pick, and place objects into the appropriate sorting bins or onto the correct conveyor paths.

Mobile robots, such as Autonomous Mobile Robots (AMRs) and Automated Guided Vehicles (AGVs), are increasingly being used in industrial settings to transport materials and goods within a facility. These robots can navigate autonomously using onboard sensors and mapping technologies. Embodiments of the present invention can be used to enhance the capabilities of mobile robots by integrating robotic systems 101 to perform tasks such as object picking, loading, and unloading. For example, a mobile robot can transport a tote containing objects to a workstation, where a robotic system 101 can then pick and place the objects as needed for a specific application, such as kitting or assembly.

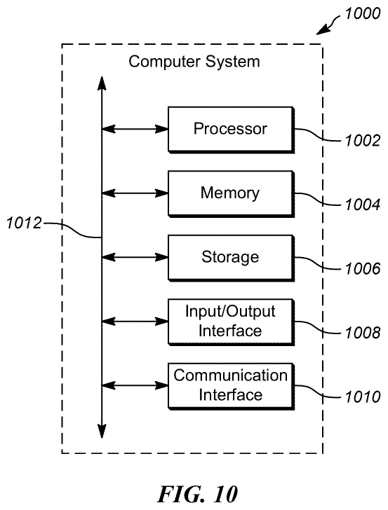

FIG. 10 depicts a computer system 1000 in accordance with embodiments. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Embodiment 1. A method comprising, by one or more computing systems: electronically receiving, from an interface device, a first natural language instruction comprising text data; electronically receiving, from a sensing system, sensor data associated with a physical environment; converting the first natural language instruction into a plurality of instruction tokens and the sensor data into a plurality of sensor tokens; executing an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generating one or more first control commands based on the control tokens; and electronically transmitting the first control commands to a robotic system, the first control commands causing the robotic system to perform an action affecting the physical environment.

Embodiment 2. The method of Embodiment 1, further comprising: electronically receiving, from the interface device, a second natural language instruction comprising text data; and performing a task comprising a plurality of actions by iteratively providing the second natural language instruction and sensor data corresponding to a current state of the robotic system to the autoregressive generative model to generate a second control command and providing the second control command to the robotic system to perform an action from among the plurality of actions.

Embodiment 3. The method of either of Embodiments 1-2, wherein at least one second control command in one iteration is a command to stop performing further actions, and wherein the at least one second control command causes the robotic system to stop performing further actions.

Embodiment 4. The method of any one of Embodiments 1-3, further comprising: within one iteration: after providing the second control command to the robotic system to perform an action, obtaining sensor data corresponding to the current state of the robotic system after performing the action; detecting an error condition based on the sensor data; and producing an output indicating a presence of the error condition.

Embodiment 5. The method of any one of Embodiments 1-4, wherein detecting the error condition based on the sensor data comprises: analyzing the sensor data to determine the current state of the robotic system; and providing the current state and a prompt to the autoregressive generative model for execution, the execution of the autoregressive generative model outputting the error condition, wherein the prompt specifies a request for the autoregressive generative model to determine whether an error has occurred.

Embodiment 6. The method of any one of Embodiments 1-5, further comprising: halting operations of the robotic system.

Embodiment 7. The method of any one of Embodiments 1-6, further comprising: within one iteration: after providing the second control command to the robotic system to perform an action, obtaining sensor data corresponding to the current state of the robotic system after performing the action; analyzing the sensor data to determine the current state of the robotic system; providing the current state and a prompt to the autoregressive generative model for execution, the execution of the autoregressive generative model outputting an indication that no error condition is detected, wherein the prompt specifies a request for the autoregressive generative model to determine whether an error has occurred; and producing an output indicating an absence of an error condition.

Embodiment 8. The method of any one of Embodiments 1-7, further comprising: within one iteration: prior to providing the second control command to the robotic system to perform an action, providing the autoregressive generative model with the control command and the current state to produce simulated sensor data corresponding to a future state of the robotic system following the execution of the second control command; and providing the autoregressive generative model with the simulated sensor data and a prompt to determine a presence or an absence of an error condition, wherein the prompt specifies a request for the autoregressive generative model to detect any erroneous condition present in the simulated sensor data.

Embodiment 9. The method of any one of Embodiments 1-8, wherein the autoregressive generative model determines a presence of an error condition, the method further comprising: halting operations of the robotic system; and producing an output indicating a presence of the error condition.

Embodiment 10. The method of any one of Embodiments 1-9, further comprising: in response to an output mode command, outputting video, image, or expected sensor data corresponding to an expected state of the robotic system after performing the action.

Embodiment 11. The method of any one of Embodiments 1-10, wherein the sensing system comprises one or more sensors.

Embodiment 12. The method of any one of Embodiments 1-11, wherein the one or more sensors are configured to provide data corresponding to a current pose of the robotic system.

Embodiment 13. The method of any one of Embodiments 1-12, wherein the sensor data indicates one or more of mass, tilt, orientation, temperature, humidity, rigidity, vibrations, atmospheric temperature, atmospheric composition, light exposure, acoustic levels, electromagnetic fields, airflow, radiation, or RFID identifiers.

Embodiment 14. The method of any one of Embodiments 1-13, wherein the sensing system comprises an imaging system.

Embodiment 15. The method of any one of Embodiments 1-14, wherein the imaging system comprises one or more of a visible light camera, an infrared camera, a LIDAR sensor, a RADAR sensor, or an ultrasonic sensor.

Embodiment 16. The method of any one of Embodiments 1-15, further comprising: receiving a second natural language instruction to place a first item in a first output area selected from a plurality of output areas, wherein the first item is selected from a plurality of items in a work area in the physical environment; and responsive to the second natural language instruction, transmitting a control command corresponding to the second natural language instruction to the robotic system, wherein the control command causes the robotic system to move the first item to the first output area.

Embodiment 17. The method of any one of Embodiments 1-16, wherein the one or more first control commands specify one or more of a specific position for the robotic system, a specific pose for the robotic system, a delta command to move a specific joint of the robotic system a specific distance, or a delta command to move a specific actuator of the robotic system a specific distance.

Embodiment 18. The method of any one of Embodiments 1-17, wherein the autoregressive generative model is a transformer model.

Embodiment 19. A system, comprising: a sensing system comprising one or more sensors configured to observe a physical environment and produce sensor data in response to the physical environment; a robotic system configured to receive control commands to perform an action affecting the physical environment; and a control system comprising one or more processors and a non-transitory memory coupled to the processors comprising instructions executable by the processors, the processors operable when executing the instructions to: electronically receive, from an interface device, a first natural language instruction comprising text data; electronically receive, from the sensing system, sensor data associated with the physical environment; convert the first natural language instruction into a plurality of instruction tokens and the sensor data into a plurality of sensor tokens; execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generate one or more first control commands based on the control tokens; and electronically transmit the first control commands to the robotic system, the first control commands causing the robotic system to perform an action affecting the physical environment.

Embodiment 20. One or more computer-readable non-transitory storage media embodying software that is operable when executed to: electronically receive, from an interface device, a first natural language instruction comprising text data; electronically receive, from a sensing system, sensor data associated with a physical environment; convert the first natural language instruction into a plurality of instruction tokens and the sensor data into a plurality of sensor tokens; execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data; generate one or more first control commands based on the control tokens; and electronically transmit the first control commands to a robotic system, the first control commands causing the robotic system to perform an action affecting the physical environment.

The flowchart and/or block diagrams in the figures illustrate the architecture, functionality, and operation of possible implementations of systems, methods and computer program products according to various embodiments of the present disclosed technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosed technology have been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the disclosed technology and the practical application, and to enable others of ordinary skill in the art to understand the disclosed technology for various embodiments with various modifications as are suited to the particular use contemplated.

Any flow diagrams depicted herein show just one example. There may be many variations to this diagram or the steps (or operations) described therein without departing from the spirit of the disclosed technology. For instance, the steps may be performed in a differing order or steps may be added, deleted or modified. All of these variations are considered a part of the claimed disclosed technology.

While the preferred embodiment to the disclosed technology had been described, it will be understood that those skilled in the art, both now and in the future, may make various improvements and enhancements which fall within the scope of the claims which follow. These claims should be construed to maintain the proper protection for the invention first described.

1. A method comprising, by one or more computing systems:
electronically receiving, from an interface device, a first natural language instruction comprising text data;
electronically receiving, from a sensing system, sensor data associated with a physical environment;
converting the first natural language instruction into a plurality of instruction tokens and the sensor data into a plurality of sensor tokens;
executing an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one modality selected from the group consisting of text data, image data, and video data and subsequently fine-tuned on one or more of sensor data or control command data;
generating one or more first control commands based on the control tokens; and
electronically transmitting the first control commands to a robotic system, the first control commands causing the robotic system to perform an action affecting the physical environment.

2. The method of claim 1, further comprising:
electronically receiving, from the interface device, a second natural language instruction comprising text data; and
performing a task comprising a plurality of actions by iteratively providing the second natural language instruction and sensor data corresponding to a current state of the robotic system to the autoregressive generative model to generate a second control command and providing the second control command to the robotic system to perform an action from among the plurality of actions.

3. The method of claim 2, wherein at least one second control command in one iteration is a command to stop performing further actions, and wherein the at least one second control command causes the robotic system to stop performing further actions.

4. The method of claim 2, further comprising:
within one iteration:
after providing the second control command to the robotic system to perform an action, obtaining sensor data corresponding to the current state of the robotic system after performing the action;
detecting an error condition based on the sensor data; and
producing an output indicating a presence of the error condition.

5. The method of claim 4, wherein detecting the error condition based on the sensor data comprises:
analyzing the sensor data to determine the current state of the robotic system; and
providing the current state and a prompt to the autoregressive generative model for execution, the execution of the autoregressive generative model outputting the error condition, wherein the prompt specifies a request for the autoregressive generative model to determine whether an error has occurred.

6. The method of claim 4, further comprising:
halting operations of the robotic system.

7. The method of claim 2, further comprising:
within one iteration:
after providing the second control command to the robotic system to perform an action, obtaining sensor data corresponding to the current state of the robotic system after performing the action;
analyzing the sensor data to determine the current state of the robotic system;
providing the current state and a prompt to the autoregressive generative model for execution, the execution of the autoregressive generative model outputting an indication that no error condition is detected, wherein the prompt specifies a request for the autoregressive generative model to determine whether an error has occurred; and
producing an output indicating an absence of an error condition.

8. The method of claim 2, further comprising:
within one iteration:
prior to providing the second control command to the robotic system to perform an action, providing the autoregressive generative model with the control command and the current state to produce simulated sensor data corresponding to a future state of the robotic system following the execution of the second control command; and
providing the autoregressive generative model with the simulated sensor data and a prompt to determine a presence or an absence of an error condition, wherein the prompt specifies a request for the autoregressive generative model to detect any erroneous condition present in the simulated sensor data.

9. The method of claim 8, wherein the autoregressive generative model determines a presence of an error condition, the method further comprising:
halting operations of the robotic system; and
producing an output indicating a presence of the error condition.

10. The method of claim 1, further comprising:
in response to an output mode command, outputting video, image, or expected sensor data corresponding to an expected state of the robotic system after performing the action.

11. The method of claim 1, wherein the sensing system comprises one or more sensors.

12. The method of claim 11, wherein the one or more sensors are configured to provide data corresponding to a current pose of the robotic system.

13. The method of claim 11, wherein the sensor data indicates one or more of mass, tilt, orientation, temperature, humidity, rigidity, vibrations, atmospheric temperature, atmospheric composition, light exposure, acoustic levels, electromagnetic fields, airflow, radiation, or RFID identifiers.

14. The method of claim 1, wherein the sensing system comprises an imaging system.

15. The method of claim 14, wherein the imaging system comprises one or more of a visible light camera, an infrared camera, a LIDAR sensor, a RADAR sensor, or an ultrasonic sensor.

16. The method of claim 1, further comprising:
receiving a second natural language instruction to place a first item in a first output area selected from a plurality of output areas, wherein the first item is selected from a plurality of items in a work area in the physical environment; and
responsive to the second natural language instruction, transmitting a control command corresponding to the second natural language instruction to the robotic system, wherein the control command causes the robotic system to move the first item to the first output area.

17. The method of claim 1, wherein the one or more first control commands specify one or more of a specific position for the robotic system, a specific pose for the robotic system, a delta command to move a specific joint of the robotic system a specific distance, or a delta command to move a specific actuator of the robotic system a specific distance.

18. The method of claim 1, wherein the autoregressive generative model is a transformer model.

19. A system, comprising:
a sensing system comprising one or more sensors configured to observe a physical environment and produce sensor data in response to the physical environment;
a robotic system configured to receive control commands to perform an action affecting the physical environment; and
a control system comprising one or more processors and a non-transitory memory coupled to the processors comprising instructions executable by the processors, the processors operable when executing the instructions to:
electronically receive, from an interface device, a first natural language instruction comprising text data;
electronically receive, from the sensing system, sensor data associated with the physical environment;
convert the first natural language instruction into a plurality of instruction tokens and the sensor data into a plurality of sensor tokens;
execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data a first tokenizer for the text data and at least one second tokenizer for the image data, video data, or control command data, and wherein the autoregressive generative model is pre-trained a corpus of general data comprising at least one of text data, image data, or video data and subsequently fine-tuned on one or more of sensor data or control command data;
generate one or more first control commands based on the control tokens; and
electronically transmit the first control commands to the robotic system, the first control commands causing the robotic system to perform an action affecting the physical environment.

20. One or more computer-readable non-transitory storage media embodying software that is operable when executed to:
electronically receive, from an interface device, a first natural language instruction comprising text data;
electronically receive, from a sensing system, sensor data associated with a physical environment;
convert the first natural language instruction into a plurality of instruction tokens and the sensor data into a plurality of sensor tokens;
execute an autoregressive generative model on the instruction tokens and sensor tokens, the executing of the autoregressive generative model outputting a plurality of control tokens, wherein the autoregressive generative model is a multimodal model configured to tokenize at least text data, image data, video data, and control command data using a first tokenizer for the text data and at least one second tokenizer for the image data, video data, or control command data, and wherein the autoregressive generative model is pre-trained on a corpus of general data comprising at least one of text data, image data, or video data and subsequently fine-tuned on one or more of sensor data or control command data;
generate one or more first control commands based on the control tokens; and
electronically transmit the first control commands to a robotic system, the first control commands causing the robotic system to perform an action affecting the physical environment.
